(19) United States
(12) Patent Application Publication
(10) Pub. No.: US 2014/0235186 A1
(43) Pub. Date: Aug. 21, 2014

(54) RADIO FREQUENCY SIGNAL TRANSMISSION METHOD AND DEVICE

(71) Applicants: Institut Polytechnique de Bordeaux, Talence (FR); STMicroelectronics S.A., Montrouge (FR)

(72) Inventors: Didier Belot, Rives (FR); Yann Deval, Bordeaux (FR); Francois Rivet, Talence (FR)

(73) Assignees: Institut Polytechnique de Bordeaux, Talence (FR); STMicroelectronics S.A., Montrouge (FR)

(21) Appl. No.: 14/177,358

(22) Filed: Feb. 11, 2014

(30) Foreign Application Priority Data
Feb. 15, 2013 (FR) 1351307

(51) Int. Cl. H04B 1/00

(52) U.S. Cl. CPC H04B 1/0021; H04B 1/0014
USPC 455/125

(57) ABSTRACT

A method for generating a radio frequency signal, wherein a signal to be transmitted is decomposed into a weighted sum of periodic basic signals of different frequencies.

### CROSS REFERENCE TO RELATED APPLICATIONS

This application claims priority to French Patent Application No. 13/51307, filed Feb. 15, 2013, which is hereby incorporated by reference to the maximum extent allowable by law.

### BACKGROUND

1. Technical Field

The present disclosure relates to the field of wireless communications, and more specifically aims at methods and devices for transmitting radio frequency signals.

2. Discussion of the Related Art

FIG. 1 is a simplified block diagram of a radio frequency signal transceiver device 100 where the processing of the radio frequency signals is of essentially digital nature.

Device 100 comprises an antenna 102 and a digital signal processor 104 (DSP) for example comprising a microprocessor. In the receive direction, the analog signal received by antenna 102 crosses a low-noise amplifier 106 (LNA), and is then directly converted into a digital signal by an analog-to-digital converter 108 (ADC) having its output connected to an input of digital processor 104. The basic signal processing operations, and especially carrier demodulation operations, are digitally carried out by device 104. In the transmit direction, device 104 directly generates a digital signal having the shape of a carrier wave modulated by the data to be transmitted, ready to be transmitted over the network. This signal is simply converted into an analog signal by a digital-to-analog converter 110 (DAC) placed at the output of device 104, and then amplified by a power amplifier 112 (PA), before being transmitted by antenna 102.

This type of device is sometimes called “radio software” since the processing implemented by the receiver and by the transmitter are essentially software in nature.

An advantage of such a device is that it is sufficient to reprogram the software part to make the device compatible with new communication standards (new carrier frequencies, new modulations, etc.).

However, in practice, the use of transceiver devices of purely software nature often may not be considered since this may require extremely fast converters and a digital processor capable of providing considerable computing power. Indeed, present communication standards use carrier frequencies on the order of a few GHz. To be able to process such signals in real time, the bandwidth of the converters and of the calculation device should be at least equal to 10 GHz. Further, to have satisfactory signal quality, a sampling over at least 16 bits should generally be provided. Converters and calculation devices capable of fulfilling such constraints have a considerable power consumption, conventionally ranging from 500 to 1,000 watts. Such a power consumption is incompatible with most network devices, and in particular with portable terminals.

FIG. 2 is a simplified block diagram of a radio frequency signal transceiver device 200, illustrating a solution which has been provided to decrease the constraints on converters and on the signal digital processor.

On the receive chain side, device 200 comprises the same elements as device 100 of FIG. 1, and further comprises a device 202 (SASP—Sampled Analog Signal Processor) for pre-processing the analog signal, arranged between the output of low-noise amplifier 106 and the input of analog-to-digital converter 108. Device 202 is configured to perform an analog pre-processing of the signal, enabling to lower the operating frequency to be able to return to conditions compatible with low power consumption conversion and digital processing devices. Functionally, device 202 selects a frequency envelope (or several envelopes in the case of a multistandard terminal) of the signal received by antenna 102, and lowers the frequency of the signal contained in this envelope. To achieve this, device 202 comprises a sampling circuit capable of delivering analog samples of the input signal, and a processing circuit capable of performing a discrete Fourier transform processing on the signal samples and of delivering first intermediate analog samples. Device 202 further comprises a processing circuit capable of modifying the spectral distribution of the first intermediate samples and of delivering second intermediate analog samples, and a processing circuit capable of performing an inverse discrete Fourier transform on the second intermediate samples and of delivering analog samples of an output signal having a lower frequency than the input signal. Detailed examples of embodiment of device 202 are described in patent application WO 2008/152322 and in article “65 nm CMOS Circuit Design of a Sampled Analog Signal Processor dedicated to RF Applications” by François Rivet et al.

The receive chain of device 200 has the advantage of providing a particularly advantageous rapidity and consumed power saving, especially in mobile telephony applications, while allowing a multistandard use and being easily reconfigurable in case of a modification of a communication standard or in case of the occurrence of a new standard.

On the transmit chain side, device 200 comprises conventional means for modulating a carrier signal with digital data. In the shown example, device 200 can alternately or simultaneously transmit data on two carrier waves P1 and P2 having different frequencies. Carrier signals P1 and P2 are respectively generated by a wave generator 204 and by a wave generator 206. Each wave generator for example comprises a voltage-controlled oscillator controlled by a quartz. A first modulator 205, for example comprising a multiplier, receives on the one hand signal P1 provided by generator 204, and on the other hand a bit train D1 of data to be transmitted provided by digital processor 104. Modulator 205 generates a signal P1′ corresponding to carrier P1 modulated by data D1 to be transmitted. A second modulator 207, for example comprising a multiplier, receives on the one hand signal P2 provided by generator 206, and on the other hand a bit train D2 of data to be transmitted provided by digital processor 104. Modulator 207 generates a signal P2′ corresponding to carrier P2 modulated by data D2 to be transmitted. Signals P1′ and P2′ are added by an adder 208, and the resulting signal is amplified by power amplifier 112, and then emitted by antenna 102.

The transmit chain of device 200 is fast and saves consumed power but has the disadvantage of not being easily reconfigurable in case of a modification of communication standards or in the case where new standards appear.

In the example of FIG. 2, the transmit chain of device 200 further comprises a counter-feedback loop enabling to verify that the signal transmitted by antenna 102 comprises no error. The counter-feedback loop comprises a coupler 210 which samples part of the output signal of power amplifier 112 (signal transmitted by antenna 102). The signal sampled by coupler 210 crosses a low-noise amplifier 212 (LNA) and a demodulation and digitization circuit 214. The digitized signal provided by circuit 214 is sent to digital processor 104, which verifies whether the signal actually coincides with that which was desired to be transmitted.

The provision of the counter-feedback loop, which actually corresponds to a simplified receive chain arranged in parallel with the main receive chain, has the disadvantage of increasing the bulk, the cost, and the power consumption of the device.

Another disadvantage is that circuit 214 generally comprises, for each communication standard capable of being used in transmit mode, a specific analog hardware demodulator. Circuit 214 is thus not easily reconfigurable in the case of a modification of communication standards.

### SUMMARY

Thus, an embodiment provides methods and devices for transmitting radio frequency signals at least partly overcoming some of the disadvantages of known methods and devices for transmitting radio frequency signals.

A first embodiment provides a device for generating a radio frequency signal capable of operating according to one or several communication standards, and easily reconfigurable in the case where a standard should be modified or where a new standard should appear.

Another embodiment provides a device for transmitting a radio frequency signal, comprising means for verifying the integrity of the transmitted signal.

A second embodiment provides a device capable of summing up analog periodic input signals by assigning a weighting coefficient to each of them.

Thus, an embodiment provides a method for generating a radio frequency signal, wherein a signal to be transmitted is decomposed into a weighted sum of periodic basic signals of different frequencies.

According to an embodiment, the highest carrier frequency comprised in said signal to be transmitted is lower than the frequency of at least one of the periodic basic signals of the decomposition.

According to an embodiment, the highest carrier frequency comprised in said signal to be transmitted is lower by at least a factor ten than the frequency of at least one of the periodic basic signals of the decomposition.

According to an embodiment, the coefficients of the decomposition are calculated by means of a digital processor.

According to an embodiment, the above-mentioned method comprises the analog generation of the basic signals, and further comprises a step of summing of said analog basic signals weighted by the coefficients calculated by the digital processor.

Another embodiment provides a device for generating a radio frequency signal, comprising a digital processing circuit configured to decompose a signal to be transmitted into a weighted sum of periodic basic signals of different frequencies.

According to an embodiment, the highest carrier frequency comprised in said signal to be transmitted is lower than the frequency of at least one of the periodic basic signals of the decomposition.

According to an embodiment, the above-mentioned device comprises means for generating in analog fashion the periodic basic signals, and means for summing up the analog signals by applying to each of them a weighting coefficient calculated by the digital processor.

According to an embodiment, the means for generating the periodic basic signals comprise a single voltage-controlled oscillator assembled in a phase-locked loop and, in series with the oscillator, a plurality of frequency dividers.

According to an embodiment, the basic signals are sinusoidal signals and the decomposition is a Fourier series decomposition.

According to an embodiment, the basic signals are square signals.

Another embodiment provides a radio frequency transceiver device, comprising a transmit device of the above-mentioned type; and a receive device comprising at least an analog pre-processing device comprising sampling means capable of delivering analog samples of an input radio frequency signal, and processing means capable of performing a discrete Fourier transform on the analog samples.

According to an embodiment, the transceiver device is configured to, during transmission phases, sample a signal representative of the transmitted signal, determine the discrete transform of this signal by means of the analog pre-processing device, digitize the discrete Fourier transform signal, and send the digitized signal to the digital processing means.

According to an embodiment, the digital processing means are configured to verify whether the received digital Fourier transform signal coincides with the decomposition in periodic basic signals calculated before the transmission.

The foregoing and other features and advantages will be discussed in detail in the following non-limiting description of specific embodiments in connection with the accompanying drawings.

### BRIEF DESCRIPTION OF THE DRAWINGS

FIG. 1, previously described, is a simplified block diagram illustrating the operation of a radio frequency signal transceiver device;

FIG. 2, previously described, is a simplified block diagram illustrating the operation of another radio frequency signal transceiver device;

FIG. 3 is a simplified block diagram illustrating the operation of an embodiment of a radio frequency signal transmit device;

FIG. 4 is a block diagram illustrating the operation of an embodiment of a generator of analog periodic signals;

FIG. 5 is a simplified block diagram illustrating an embodiment of a radio frequency signal transceiver device; and

FIG. 6 is a schematic diagram of an embodiment of a device capable of summing up periodic analog input signals by assigning a weighting coefficient to each of them.

For clarity, the same elements have been designated with the same reference numerals in the different drawings.

### DETAILED DESCRIPTION

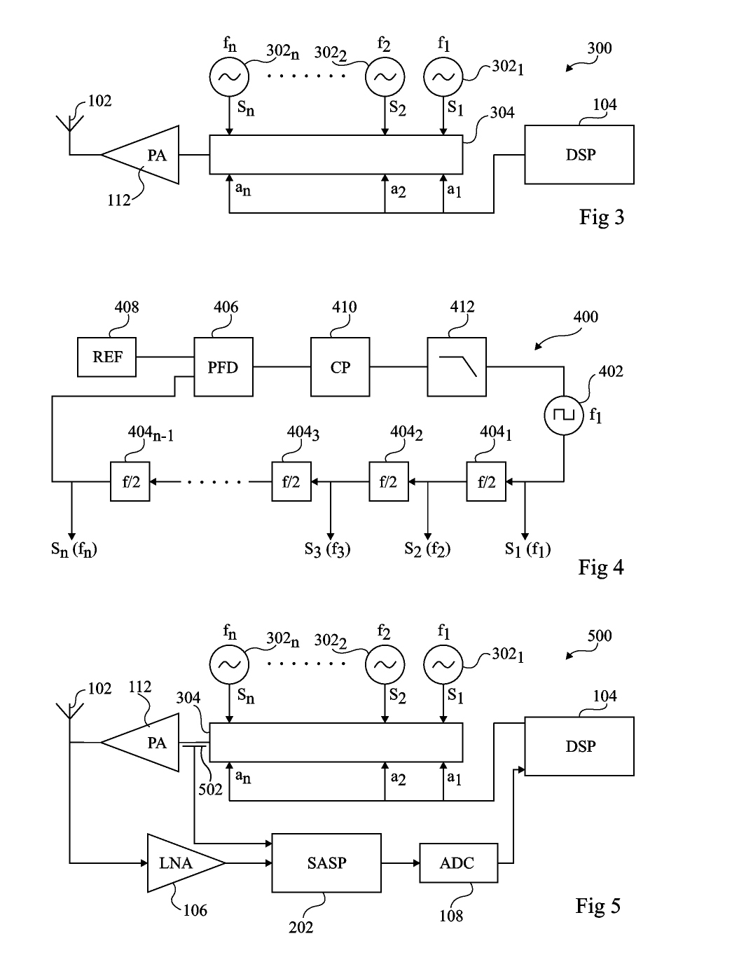

FIG. 3 is a simplified block diagram illustrating the operation of an embodiment of a device 300 for transmitting radio frequency signals, capable of being easily reconfigured in the case where a communication standard should be modified or where one or several new standards should appear.

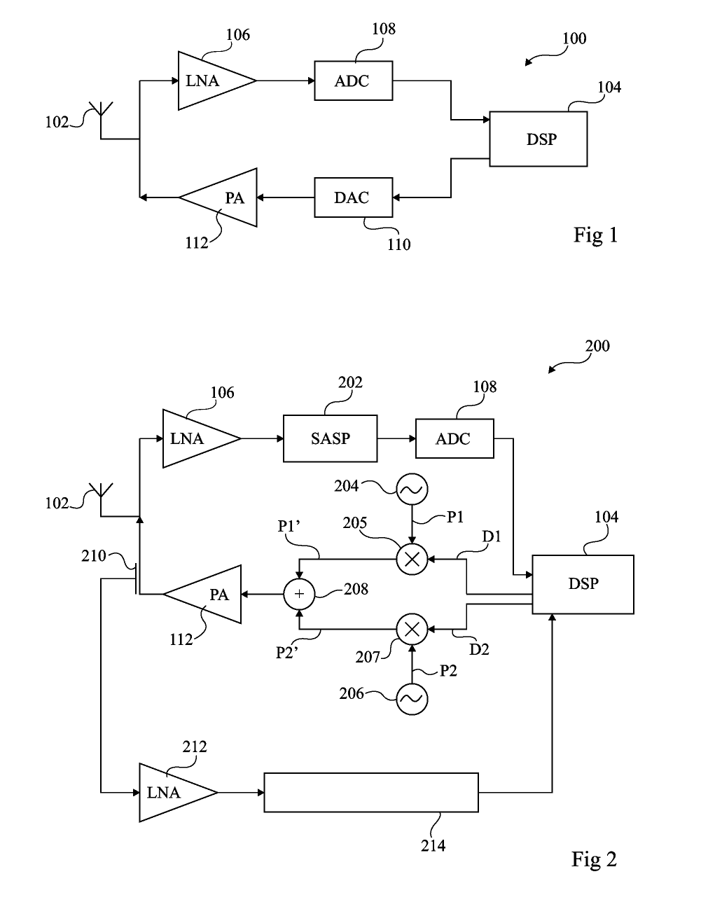

Like devices 100 of FIGS. 1 and 200 of FIG. 2, device 300 comprises an antenna 102, and a device 104 for digitally processing the signal for example comprising a microprocessor. Device 300 further comprises means for generating a range of a plurality of analog periodic basic signals of different frequencies. In the shown example, device 300 comprises n periodic signal generators (n being an integer greater than 1) bearing references 302₁ to 302ₙ. Each generator 302ᵢ (with i ranging from 1 to n) provides a periodic signal Sᵢ of frequency fᵢ, for example, a sinusoidal signal or a square signal. Each generator 302ᵢ for example comprises a voltage-controlled oscillator, controlled by a reference source which may comprise a quartz, by means of a phase-locked loop. Device 300 further comprises a circuit 304 capable of performing a weighted sum of the n periodic signals Sᵢ in the range, by assigning a weighting coefficient aᵢ to each of them. In the shown example, device 304 comprises n inputs connected to generators 302₁ to 302ₙ and intended to respectively receive the n signals S₁ to Sₙ in the range, and further comprises n inputs connected to the output of digital processing device 104 and intended to respectively receive the n weighting coefficients a₁ to aₙ to be assigned to signals S₁ to Sₙ. Digital-to-analog converters, not shown, may be provided between the output of device 104 and inputs a₁ to aₙ of device 304. The output of circuit 304 is connected to antenna 102, for example, via a power amplifier 112.

When the range of basic signals contains a sufficient number of basic frequencies fᵢ, any signal capable of being transmitted by device 300 may be approximated by a weighted sum of signals S₁ to Sₙ.

According to a first aspect, digital processor 104 is configured, for example, by means of an adapted software, to calculate coefficients a₁ to aₙ so that the weighted sum of basic signals Sᵢ of the range corresponds to the radio frequency signal which is desired to be transmitted or, in other words, to decompose the signal to be transmitted into a weighted sum of basic signals Sᵢ of the range.

In the specific case where signals S₁ to Sₙ are sinusoidal signals, the decomposition is a Fourier series decomposition. Weighting coefficients aᵢ may be determined by calculation by digital processing unit 104, by means of mathematical formulas, by taking into account the data to be transmitted, the frequency of the carrier wave(s) to be transmitted, and the type of modulation used.

In the case where signals S₁ to Sₙ have a shape other than sinusoidal, for example, a square shape, weighting coefficients a₁ to aₙ may be calculated by digital processing unit 104 either directly, by means of mathematical decomposition formulas, or, if such formulas cannot be easily determined, by means of an iterative method of minimization of the error function between the signal to be transmitted and the decomposition into the series of basic signals. As an example, it may be provided, in an initial step, to use as weighting coefficients the coefficients of the Fourier series decomposition of the signal to be transmitted, and then to iteratively adjust the coefficients to minimize the error between the weighted sum of the basic signals and the signal which is effectively desired to be transmitted.

In practice, the decomposition of the signal to be transmitted may be calculated in successive time windows, for example, windows having a duration ranging between a few microseconds and a few hundreds of microseconds, for example, between 10 and 200 microseconds. To accelerate the processing, it may be provided to implement the decomposition calculation on a sliding window, that is, between two successive steps of calculation of the weighting coefficients, the processing slot is offset by a number of samples smaller than its total width.

Number n of basic signals Sᵢ of the range preferably ranges between 5 and 20, and each signal Sᵢ has a frequency fᵢ equal to half frequency fᵢ₋₁ of signal Sᵢ₋₁ of previous rank. Frequency f₁ of signal S₁, provided by generator 302₁ having the lowest rank, is preferably selected to be at least ten times greater than the highest carrier frequency on which the device should be able to transmit. Frequency f₁ is for example on the order of 60 GHz for mobile telephony applications. The described embodiments are not however limited to the described examples, and it will be within the abilities of those skilled in the art to provide other adapted choices for the basic signal range. Anyway, at least part of basic signals Sᵢ of the range have a frequency fᵢ greater than the highest carrier frequency at which the device is capable of transmitting.

An advantage of the transmit device described in relation with FIG. 3 is that, in case of a modification of one or several transmission standards (carrier frequency, modulation type, etc.), the device can easily be reconfigured, for example, by simple software reprogramming, to be made compatible with the new standard(s).

Another advantage is that the determination of the n weighting coefficients aᵢ corresponding to the radio frequency signal to be transmitted only requires a lower calculation power, and in particular does not require generating a full digital version of the radio frequency signal to be transmitted.

Another advantage is that the selection of the hardware components provided between digital processor 104 and power amplifier 112 (and the selection of generators 302ᵢ in the example of FIG. 3) is independent from the number of communication standards with which device 300 should be able to transmit. Thus, a transmission chain provided to transmit in a large number of standards will not be more bulky, expensive, or power consuming than a transmit chain provided to transmit in a single standard.

FIG. 4 illustrates a preferred embodiment where a single generator 400 is used to provide all the basic signals S₁ to Sₙ of the range. FIG. 4 is a block diagram illustrating an embodiment of such a generator.

Generator 400 comprises a voltage-controlled oscillator 402, providing a periodic analog signal S₁ of frequency f₁, for example, a square signal at 60 GHz. Generator 400 further comprises n−1 frequency dividers, bearing references 404₁ to 404ₙ₋₁ in the drawing. Dividers 404₁ to 404ₙ are series—connected, first divider 404₁ of the series receiving signal S₁ as an input. Each divider 404ᵢ delivers a signal Sᵢ₊₁, for example, square, having a frequency fᵢ₊₁ equal to half frequency fᵢ of signal Sᵢ that it receives. Oscillator 402 is for example controlled by a signal provided by a reference source which may comprise a quartz. In the shown example, oscillator 402 and dividers 404₁ to 404ₙ₋₁ are assembled in a phase-locked loop comprising a phase comparator 406 (PFD—Phase Frequency Detector) receiving, on the one hand, signal Sₙ provided by last divider 404ₙ₋₁ of the series and, on the other hand, a reference signal provided by a reference source 408 (REF) comprising a quartz. In this example, the output of phase comparator 406 is connected to the input of a charge pump 410 (CP), and the signal provided by charge pump 410 passes through a loop filter 412 having its output connected to the voltage control input of oscillator 402. In operation, basic analog signals S₁ to Sₙ are respectively available at the output of oscillator 402 and at the output of frequency dividers 404₁ to 404ₙ₋₁.

An advantage of the embodiment of FIG. 4 is that all the basic signals Sᵢ in the range are generated by using a single voltage-controlled oscillator, and a single phase-locked loop, which decreases the bulk, the cost, and the power consumption of the transmit device.

It will be within the abilities of those skilled in the art to adapt the generator described in relation with FIG. 4 to obtain other ranges of basic signals Sᵢ, for example, by varying the division ratios of frequency dividers 404ᵢ.

FIG. 5 is a simplified block diagram illustrating an embodiment of a radio frequency transmit/receive device 500, this device comprising control circuits for verifying the integrity of the signals that it transmits over the network.

Device 500 comprises a transmit chain of the type described in relation with FIGS. 3 and 4, that is, where the transmitted signal is generated by weighted summing of a plurality of analog periodic basic signals Sᵢ, the weighting coefficients being determined by means of a digital processor. In the shown example, the transmit chain of device 500 comprises the same elements as transmit chain 300 of FIG. 3. Device 500 further comprises a receive chain of the type described in relation with FIG. 2, that is, comprising a pre-processor for processing analog samples of the signal, capable of selecting one or several frequency envelope(s) of the radio frequency signal received by the antenna and of lowering the frequency of the signal contained in these envelope(s). In the shown example, the receive chain of device 500 comprises the same elements as the receive chain of device 200 of FIG. 2.

In the embodiment of FIG. 5, when device 500 operates in transmission mode, a signal representative of the signal transmitted by antenna 102 is sampled from the transmit chain, processed by analog pre-processor 202 (SASP) of the receive chain, and sent to digital processor 104, which verifies its integrity. In the shown example, a portion of the output signal of circuit 304 (that is, the weighted sum of analog basic signals Sᵢ) is sampled via a coupler 502, and sent to analog pre-processing device 202. As previously discussed in relation with FIG. 2, device 202 comprises a sampling circuit capable of delivering analog samples of an input signal, and a processing circuit capable of performing a discrete Fourier transform processing on the signal samples. It is provided, when device 500 operates in transmission mode, to activate device 202 to calculate the discrete Fourier transform of the signal provided by coupler 502. The discrete Fourier transform signal generated by device 202 is then digitized by converter 108, and then sent to digital processor 104. Device 104 is configured, for example, by means of an adapted software, to verify that the received Fourier transform signal is coherent with the previously-calculated decomposition into periodic basic signals Sᵢ.

An advantage of the transceiver device of FIG. 5 is that it enables to verify the integrity of the signal transmitted by antenna 102 without requiring, for this purpose, providing a specific counter-feedback loop of the type described in relation with FIG. 2. This enables to decrease the bulk, the cost, and the power consumption with respect to the device of FIG. 2.

Another advantage of device 500 is that, in case one or several communication standards have been modified, it can easily be made compatible with the new standard(s). In particular, the function of verification of the integrity of the transmitted signal requires no specific update or reconfiguration to operate with new transmission standards.

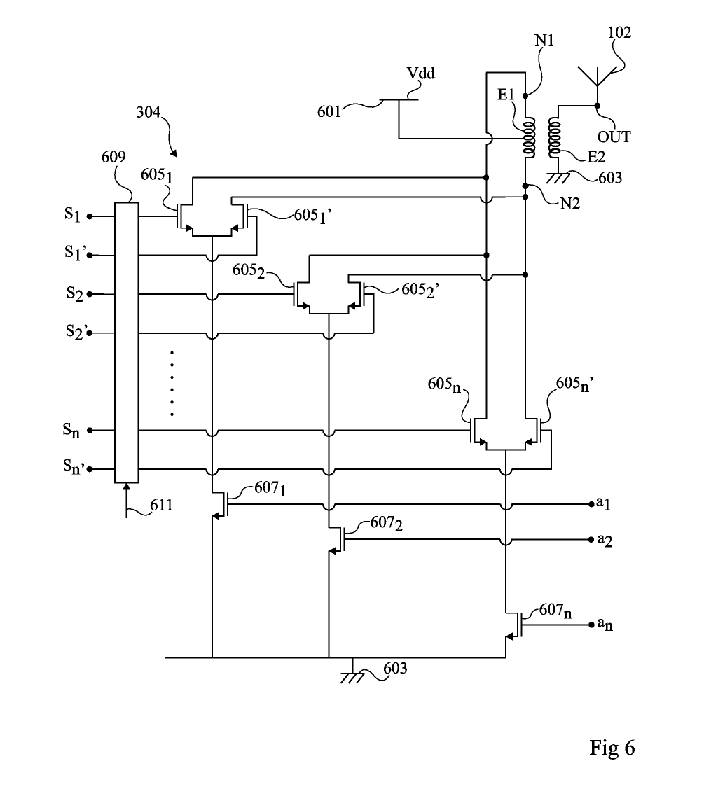

FIG. 6 is a schematic diagram illustrating an embodiment of a circuit 304 according to the second aspect, capable of summing up a plurality of analog periodic input signals Sᵢ by assigning a weighting coefficient aᵢ to each of them. Circuit 304 of FIG. 6 may for example be used as a weighted summing circuit in the radio frequency transmit devices of FIGS. 3 and 5.

Circuit 304 comprises a high power supply terminal or line 601 (V_{dd}) and a low power supply terminal or line 603 (or ground terminal). It further comprises n inputs S₁ to Sₙ intended to respectively receive n periodic analog signals to be summed up and n inputs S₁′ to Sₙ′ intended to respectively receive the complementaries of the signals to be summed up, that is, signals having the same characteristics as the signals to be summed up, but with a 180° phase shift. Circuit 304 comprises a balun comprising two conductive windings E1 and E2 coupled to each other. The ends of winding E1 define differential access terminals N1 and N2, an intermediate point of winding E1 being connected to a reference terminal, for example, high power supply terminal 601. The ends of common-mode winding E2 are respectively connected to an output terminal OUT and to a reference terminal, for example, low power supply terminal 603. Circuit 304 further comprises, associated with each of input terminals Sᵢ, a switch 605ᵢ, and a variable current source 607ᵢ. A first conduction electrode of switch 605ᵢ is connected to node N1, and the second conduction electrode of switch 605ᵢ is connected to low power supply terminal 603 via variable current source 607ᵢ. The control terminal of switch 605ᵢ is connected to input terminal Sᵢ. In the example of FIG. 6, switch 605ᵢ is an N-channel MOS transistor having its drain connected to node N1 and having its gate connected to terminal Sᵢ, and current source 607ᵢ is an N-channel MOS transistor having its source and its drain respectively connected to low power supply terminal 603 and to the source of transistor 605ᵢ. Circuit 304 further comprises, associated with each of input terminals Sᵢ′, a switch 605ᵢ′ having a first conduction electrode connected to node N2 and having its second conduction electrode connected to the second conduction electrode of switch 605ᵢ. The control terminal of switch 605ᵢ′ is connected to input terminal Sᵢ′. In the example of FIG. 6, switch 605ᵢ′ is an N-channel MOS transistor having its drain connected to node N2, having its gate connected to terminal Sᵢ′, and having its source connected to the source of transistor 605ᵢ. Circuit 304 further comprises n inputs a₁ to aₙ intended to receive voltage references proportional to the absolute values of the weighting coefficients to be applied to the signals to be summed up. Inputs a₁ to aₙ are successively connected to the control terminals of variable current sources 607₁ to 607ₙ, that is, to the gates of N-channel MOS transistors 607₁ à 607ₙ in the shown example.

In operation, input terminals S₁ to Sₙ and S₁′ to Sₙ′ receive the signals to be summed up and their complementaries, and input terminals a₁ to aₙ receive voltage references proportional to the absolute values of the weighting coefficients to be applied to the signals to be summed up. As an example, in the case where circuit 304 is used in a radio frequency transmission circuit of the type described in relation with FIGS. 3 and 5, the references to be applied to terminals a₁ to aₙ are digitally determined by digital processor 104, and digital-to-analog converters, not shown, convert the digital reference values into analog values applicable to terminals a₁ to aₙ. To take into account, in the weighted sum, the sign of the weighting coefficients, the fact of having, at the input, not only basic signals Sᵢ to be summed up, but also their complementaries Sᵢ′, is used. When the coefficient to be applied to a given input signal Sᵢ is negative, the complementary signal Sᵢ′ to which the absolute value of the weighting coefficient is applied is used to generate the corresponding term of the weighted sum. To achieve this, between input terminals Sᵢ and Sᵢ′, on the one hand, and the control terminals of switches 605ᵢ and 605ᵢ′ on the other hand, a circuit 609 configured to activate terminal Sᵢ and deactivate Sᵢ′ is provided when coefficient aᵢ to be applied has a positive sign, and to deactivate terminal Sᵢ and activate terminal Sᵢ′ when coefficient aᵢ to be applied has a negative sign. Circuit 609 comprises an input 611 for receiving the sign information of coefficients aᵢ, for example, from digital processor 104 in the case where circuit 304 is used in a radio frequency transmission circuit of the type described in relation with FIGS. 3 and 5. If the coefficient to be applied to a given input signal Sᵢ is positive, switch 605ᵢ′ connected to the corresponding complementary input Sᵢ′ is deactivated, that is, it is forced to the off state by circuit 609, and switch 605ᵢ remains active, that is, its state is a function of the state of signal Sᵢ. If the coefficient to be applied to a given input signal Sᵢ is negative, switch 605ᵢ connected to input Sᵢ is deactivated (forced to the off state by circuit 609) and switch 605ᵢ′ remains active (state depending on the state of complementary signal Sᵢ′).

Input signals Sᵢ and Sᵢ′ being periodic A.C. signals (for example, sinusoidal or square signals), active switches 605ᵢ or 605ᵢ′ (according to whether the sign of weighting coefficient aᵢ is positive or negative) periodically switch from an on state to an off state. In the case of a positive weighting coefficient aᵢ (switch 605ᵢ active), when switch 605ᵢ is conductive (high state of input signal Sᵢ), a current flows from high power supply terminal 601 to low power supply terminal 603, through the portion of winding E1 located between terminal 601 and node N1, through switch 605ᵢ, and through current source 607ᵢ. The intensity of this current depends on the voltage applied to control terminal aᵢ of variable voltage source 607ᵢ. When switch 605ᵢ is non-conductive (low state of input signal Sᵢ), this current stops. In the case of a negative weighting coefficient aᵢ (switch 605ᵢ′ active), when switch 605ᵢ′ is conductive (high state of input signal Sᵢ′), a current flows from high power supply terminal 601 to low power supply terminal 603, through the portion of winding E1 located between terminal 601 and node N2, through switch 605ᵢ′, and through current source 607ᵢ. The intensity of this current depends on the voltage applied to control terminal aᵢ of variable voltage source 607ᵢ. When switch 605ᵢ′ is non-conductive (low state of input signal Sᵢ′), this current stops.

The currents provided by current sources 607ᵢ add at the level of nodes N1 (for positive weighting coefficients aᵢ) and N2 (for negative weighting coefficients aᵢ). The current which flows through winding E1 is representative of the sum of input signals Sᵢ weighted by coefficients aᵢ. This current is copied, by inductive coupling, on winding E2. The voltage variation across winding E2 is thus representative of the weighted sum of input signals Sᵢ.

In the case where circuit 304 is used in a transmit circuit of the type described in relation with FIGS. 3 and 5, node OUT may be connected to a transmit antenna 102. If transistors 605ᵢ, 605ᵢ′, 607ᵢ and windings E1 and E2 are properly sized, it may advantageously be done without a power amplifier between the output of circuit 304 and antenna 102.

An advantage of circuit 304 is that it is easy to form and enables to efficiently perform a weighted summing of periodic A.C. input signals.

The embodiments described in relation with FIG. 6 are not limited to the case where the transistors used to form switches 605ᵢ, 605ᵢ′, and 607ᵢ are N-channel MOS transistors. It will be within the abilities of those skilled in the art to implement the desired operation by using P-channel MOS transistors and by inverting, if need be, the biasing of the circuit power supply terminals.

Further, the embodiments described in relation with FIG. 6 are not limited to a use of circuit 304 in a radio frequency signal transmit device of the type described in relation with FIGS. 3 and 5. Such a circuit may also be used in any other application requiring the implementation of a weighted sum of periodic analog signals.

Various embodiments with different variations have been described hereabove. It should be noted that those skilled in the art may combine various elements of these various embodiments and variations.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A method for generating a radio frequency signal, wherein a signal to be transmitted is decomposed into a weighted sum of periodic basic signals of different frequencies.

2. The method of claim 1, wherein the highest carrier frequency comprised in said signal to be transmitted is lower than the frequency of at least one of the periodic basic signals of the decomposition.

3. The method of claim 2, wherein the highest carrier frequency comprised in said signal to be transmitted is lower by at least a factor ten than the frequency of at least one of the periodic basic signals of the decomposition.

4. The method of claim 1, wherein the coefficients of the decomposition are calculated by means of a digital processor.

5. The method of claim 4, comprising analog generation of the basic signals, and further comprising a step of summing of said analog basic signals weighted by the coefficients calculated by the digital processor.

6. A device for generating a radio frequency signal, comprising a digital processing circuit configured to decompose a signal to be transmitted into a weighted sum of periodic basic signals of different frequencies.

7. The device of claim 6, wherein the highest carrier frequency comprised in said signal to be transmitted is lower than the frequency of at least one of the periodic basic signals of the decomposition.

8. The device of claim 6, comprising means for generating, in analog fashion, the periodic basic signals, and means for summing up the analog signals by applying to each of them a weighting coefficient calculated by the digital processor.

9. The device of claim 8, wherein said means for generating the periodic basic signals comprise a single voltage-controlled oscillator assembled in a phase-locked loop and, in series with the oscillator, a plurality of frequency dividers.

10. The device of claim 6, wherein said basic signals are sinusoidal signals and said decomposition is a Fourier series decomposition.

11. The device of claim 6, wherein said basic signals are square signals.

12. A radio frequency transceiver device comprising:
the transmit device of claim 6; and
a receive device comprising at least an analog pre-processing device comprising sampling means capable of delivering analog samples of an input radio frequency signal, and processing means capable of performing a discrete Fourier transform on said analog samples.

13. The device of claim 12, configured to, in transmission phases, sample a signal representative of the transmitted signal, determine the discrete transform of this signal by means of the analog pre-processing device, digitize the discrete Fourier transform signal, and send the digitized signal to said digital processing means.

14. The device of claim 13, wherein said digital processing means are configured to verify whether the received digital Fourier transform signal coincides with the decomposition into periodic basic signals calculated before the transmission.
